(19) United States
(12) Patent Application Publication
(10) Pub. No.: US 2026/0094179 A1
(43) Pub. Date: Apr. 2, 2026

(54) GENERATIVE OFFER SYSTEM WITH MULTILINGUAL AI-DRIVEN VOICE ASSISTANT FOR REAL-TIME COMMERCE

(71) Applicant: Stephen M. Byrd, Upper Marlboro, MD (US)

(72) Inventor: Stephen M. Byrd, Upper Marlboro, MD (US)

(21) Appl. No.: 19/295,646

(22) Filed: Aug. 10, 2025

Related U.S. Application Data
(63) Continuation-in-part of application No. 16/823,370, filed on Mar. 19, 2020, now abandoned.
(63) Continuation-in-part of application No. 17/408,858, filed on Aug. 23, 2021, now abandoned.

(51) Int. Cl. G06Q 30/0207; G06Q 30/0208; G06Q 30/0211; G10L 15/00

(52) U.S. Cl. CPC G06Q 30/0224; G06Q 30/0208; G06Q 30/0211; G06Q 30/0222; G10L 15/005

(57) ABSTRACT

A system and method for generating and delivering personalized promotional offers in real time in response to user voice input. The system processes natural language queries and analyzes prior purchase history, inferred preferences, historical interactions, environmental context including device type, location, and time, and ongoing behavioral signals. Machine learning models adapt future offers based on accumulated user data to provide evolving personalization. The system supports multilingual speech recognition and can operate across smartphones, voice assistants, wearables, smart televisions, extended reality environments, and large language models. Offers may be delivered through audio, visual, or haptic interfaces to enable integration into commerce and advertising platforms. The combination of speech-triggered interaction, adaptive personalization, and contextual awareness enables dynamic, AI-driven promotional flows that operate consistently across multiple platforms and languages.

### CROSS REFERENCE TO RELATED APPLICATIONS

The present application is a Continuation-In-Part application of U.S. patent application Ser. No. 16/823,370 filed on 19 Mar. 2020, and patent application Ser. No. 17/408,858 filed on 23 Aug. 2021 which are herein incorporated in their entirety.

### FIELD OF THE DISCLOSURE

The present disclosure relates generally to systems and methods for generating and delivering personalized promotional offers, and more particularly to AI-driven, voice-activated systems capable of processing multilingual natural language input to produce real-time, context-aware, adaptive promotions across multiple platforms and interfaces.

### BACKGROUND OF THE RELATED ART

Voice-enabled systems and AI-powered assistants have become common in smartphones, connected devices, and virtual platforms, enabling users to perform searches, access services, and control devices through natural language commands. While some solutions incorporate advertising or promotional functions, these are typically static, preprogrammed, and not dynamically generated based on a user's real-time request.

Existing systems often fail to integrate contextual factors such as prior purchase history, inferred preferences, environmental conditions, and ongoing behavioral patterns when generating offers. Furthermore, most voice-based promotional systems lack multilingual support, limiting their accessibility and effectiveness in global markets.

Current approaches also do not provide seamless interoperability across diverse platforms, including mobile devices, wearables, smart televisions, extended reality environments, and large language models. There is a need for an AI-driven voice platform capable of generating context-aware, multilingual promotional offers in real time, adapting to evolving user behavior, and operating across multiple interface types and ecosystems.

### DESCRIPTION OF RELATED ARTS

US granted patent, U.S. Ser. No. 7136470B1 discloses a conventional telecommunications systems play a standard ringing tone to the caller while waiting for the recipient to answer. However, this waiting period is often unproductive. A prior approach proposed replacing the ringing tone with relevant information such as advertisements, delivered to the caller before the call is answered. These ads could be location-based or interest-specific and funded by advertisers, offering potential cost savings to the caller. This system enables passive ad delivery during idle call time, but it is limited to telephony contexts and does not support active user engagement, AI-driven personalization, or multimodal platforms like smart devices, virtual environments, or conversational interfaces.

‘Nova Spivack et al.’ in a US granted patent U.S. Pat. No. U.S. Ser. No. 11/494,991B2, discloses existing systems have explored the use of digital assistants within augmented reality (AR) environments, enabling users to interact with virtual elements overlaid on the physical world. These systems often use directional lenses or display apparatuses as portals between real and digital spaces. The digital assistant can be presented within the AR environment and respond to user commands by triggering actions or manipulating virtual content. Some systems incorporate adaptive learning, allowing the assistant to learn from user behavior and interactions within the AR space. While these systems offer immersive interaction, they primarily focus on AR-specific content manipulation and lack dedicated voice-based monetization mechanisms, contextual commerce integration, or scalable deployment across smart platforms and AI ecosystems.

In yet another patent application, bearing application number US20210134263A1, Victor et al. discloses a platform and system for the transcription of electronic online content from mostly visual/text format to an aural format, adapted for being read by an intelligent speaker system. It specifically discloses an automated engine with artificial intelligence and/or machine learning for the transformation of written websites into audio enabled content for use in association with new technology intelligent speakers, for implementing data mining, processing, and summarizing tools.

Another granted patent to Apple Inc., U.S. Pat. No. 9,548,050B2 filed by Thomas et al. teaches about an intelligent automated assistant system that engages with the user in an integrated, conversational manner using natural language dialog, and invokes external services when appropriate to obtain information or perform various actions.

Voice-interactive systems have become widely adopted in consumer devices, including smartphones, smart speakers, connected home appliances, wearable devices, and vehicle infotainment systems. These systems allow users to interact through spoken commands, leveraging natural language processing to retrieve information, execute actions, and in some cases, deliver recommendations or promotional content. Common examples include voice assistants such as Amazon Alexa, Apple Siri, Google Assistant, and similar AI-powered conversational interfaces.

Some machine learning-based advertising systems exist, primarily within e-commerce platforms, that generate product recommendations based on purchase history or browsing patterns. However, these solutions are generally visual in nature, integrated into websites or mobile applications, and are not optimized for voice-based, hands-free interactions. Furthermore, they typically do not combine multilingual natural language understanding with adaptive promotional delivery, limiting their reach in global and multilingual markets.

Cross-platform operation is another limitation in current systems. Many voice-interactive platforms are proprietary and operate within restricted ecosystems, reducing interoperability with external devices, applications, or environments. For example, a voice assistant embedded in a smartphone may not seamlessly transfer a personalized promotional flow to a virtual reality (VR) headset, a smart television, or an AI chatbot environment.

Consequently, there remains an unmet need for a voice-driven, AI-enabled system that can generate contextually relevant promotional offers in real time, adapt over time through machine learning, support speech recognition in multiple languages and dialects, and operate consistently across diverse platforms and interface types, including mobile devices, wearables, VR/AR systems, smart televisions, and large language models.

### SUMMARY OF THE INVENTION

The present disclosure describes systems and methods for generating, delivering, and refining personalized promotional offers in real time using artificial intelligence (AI) integrated with multilingual voice-interactive technologies.

In certain embodiments, the system receives a spoken request from a user through a voice-enabled device, such as a smart speaker, smartphone, wearable device, smart television, or virtual reality headset. The spoken request is captured by one or more microphones and processed by a multilingual natural language processing (NLP) engine capable of interpreting multiple languages and dialects.

Upon receiving the input, the system analyzes the request in combination with contextual information. Contextual factors may include prior purchase history, user preferences inferred from historical behavior, demographic data, real-time environmental conditions (e.g., location, device type, time of day), and interaction history across multiple platforms.

The system architecture incorporates a generative AI engine trained on commercial, behavioral, and contextual datasets. This engine produces promotional offers that are relevant to the specific query and circumstances of the user. Unlike static recommendation systems, the generative AI module dynamically constructs offers in real time, which may include discounts, bundled promotions, or curated product/service suggestions.

The offers may be delivered in various formats, including audio announcements, on-screen displays, interactive graphics, or haptic notifications, depending on the capabilities of the user's device and the nature of the interaction environment.

The system employs adaptive machine learning algorithms that continually refine the promotional output. Each interaction provides new data, which is anonymized, aggregated, and used to improve the underlying models, enhancing both personalization and conversion rates over time.

Multilingual capabilities allow the system to interpret, generate, and deliver promotional content in different languages and dialects without loss of meaning or relevance. This enables global deployment and ensures that users receive contextually appropriate offers regardless of geographic or linguistic differences.

Cross-platform operability allows the system to function across multiple devices and ecosystems, such as mobile operating systems, virtual reality platforms, large language models, and proprietary voice assistants. Interoperability protocols enable seamless transition of an active promotional session from one device to another.

The system's data processing layer may integrate with external commerce and advertising platforms, payment gateways, and inventory management systems to ensure that offers are accurate, up to date, and actionable at the moment they are delivered.

Offers can be interactive, allowing users to accept, reject, or modify the terms via voice commands. This interactivity enables dynamic adjustments, such as updating a discount in response to a counter-offer or adding additional items to a bundle based on user feedback.

The system is designed to recognize and act upon contextual triggers during an active session. For example, if a user requests information on televisions under a certain budget, the system may present three qualifying options and offer an additional discount in exchange for listening to a brief sponsored message.

Device-specific optimization ensures that offers are displayed or presented in a format suitable for the current hardware, whether that is immersive VR visuals, compact smartwatch notifications, or audio-only outputs.

The architecture supports real-time adaptation within a session. If new contextual data becomes available, such as a location change or updated inventory, the system can adjust the offer dynamically before the interaction concludes.

In some embodiments, a cloud-based coordination layer manages the AI processing, offer generation, and data synchronization across all connected devices for a single user.

Privacy and compliance mechanisms are incorporated to meet data protection regulations. All behavioral and contextual data used for training and personalization is processed in compliance with applicable laws, with options for user consent and opt-out.

The system's machine learning models may be trained using historical transaction data, simulated user interactions, and live feedback loops to ensure adaptability to emerging trends and seasonal changes.

The multilingual NLP engine is capable of handling regional variations, colloquial expressions, and domain-specific vocabulary, allowing the promotional content to remain natural and persuasive across cultural contexts.

In addition to consumer-facing use cases, the system may be deployed in business-to-business environments, enabling personalized offers for enterprise procurement, vendor negotiations, and professional services.

The platform supports integration with augmented reality (AR) and mixed reality (MR) devices, allowing visual overlay of promotional offers within a user's physical or virtual environment.

By combining generative AI, contextual awareness, multilingual support, and cross-platform interoperability into a unified system, the present disclosure addresses the limitations of existing static and monolingual voice-interactive advertising solutions.

The invention enables a highly adaptive, interactive, and scalable framework for delivering personalized, real-time promotional offers, enhancing user engagement and providing measurable commercial benefits across diverse industries and global markets.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating an embodiment of a generative offer system with a multilingual AI-driven voice assistant, showing primary system components including voice input devices, a multilingual natural language processing engine, a contextual analysis module, and a generative AI offer engine, according to some embodiments of the present disclosure.

FIG. 2 s a block diagram further illustrating the integration of the generative offer system with cross-platform environments, including smartphones, smart speakers, wearable devices, smart televisions, and virtual/augmented reality systems, according to some embodiments of the present disclosure.

FIG. 3 is a flow diagram illustrating a method for receiving a voice request, processing the request in multiple languages, analyzing contextual data, and generating a personalized promotional offer using a generative AI engine, according to some embodiments of the present disclosure.

FIG. 4 is a flow diagram further illustrating adaptive machine learning within the generative offer system, showing how user interactions and feedback are used to refine future promotional offers and enhance personalization over time, according to some embodiments of the present disclosure.

### DETAILED DESCRIPTION OF THE INVENTION

Unless otherwise defined, all technical terms used herein related to voice recognition, artificial intelligence, machine learning, natural language processing, neural machine translation, search algorithms, contextual data analysis, virtual and augmented reality, and e-commerce systems have the same meaning as commonly understood by those skilled in the relevant arts. Terms such as “speech recognition,” “automatic speech recognition (ASR),” “natural language processing (NLP),” “named entity recognition (NER),” “multilingual support,” “contextual analysis,” “generative AI,” “reinforcement learning,” “immersive virtual environment,” “personalized offer,” and “contextual voice advertisement” are to be interpreted consistent with their use in this specification and the state of the art. For brevity, well-known functions or constructions related to these fields may not be described in detail unless necessary for understanding the invention.

The detailed description herein describes embodiments of a generative offer system with multilingual, AI-driven voice assistant capabilities. The embodiments are illustrative and not limiting; elements described as being “in some embodiments” may be combined in other embodiments unless the context requires otherwise.

In general terms, the system receives voice input from a user, interprets the input using multilingual automatic speech recognition (ASR) and natural language understanding (NLU), determines contextual and user-specific data relevant to the request, generates one or more personalized promotional offers using a generative AI engine, ranks and formats the offers for delivery, presents the offers through one or more output channels, and updates adaptive learning models based on interaction data to refine future offer generation.

The system is composed of modular components that may be implemented in hardware, software, firmware, or any combination thereof. In some embodiments, components are distributed between one or more client devices and one or more cloud servers. In other embodiments, portions of processing occur at the edge or entirely on the client device to reduce latency or satisfy privacy constraints.

As used herein, “user-specific context” or “user context” includes, without limitation: prior purchase history; inferred preferences derived from historical interactions; demographic and profile data; device characteristics; geolocation; temporal data such as time of day and calendar context; session history and in-session interaction signals; and environmental context such as ambient noise level or network connectivity. Use of the term “contextual analysis” encompasses any algorithmic process that leverages one or more of these signals to produce a context vector or other representation used for personalization.

The term “generative AI engine” refers to one or more machine learning models configured to synthesize promotional content, offer parameters, or other candidate promotional outputs in real time. The generative AI engine may implement transformer models, sequence-to-sequence models, ranking models, generative adversarial networks, or other suitable architectures. In some embodiments the generative AI engine produces textual offer scripts, numeric discount parameters, and metadata required for offer presentation (e.g., duration, call-to-action, tracking identifiers).

In some embodiments, the system includes privacy and compliance mechanisms configured to perform consent checks, data anonymization, pseudonymization, data minimization, and retention enforcement in accordance with applicable law. In some embodiments, user consent settings govern whether behavioral data is used to train models or to personalize offers for a particular user.

The system supports multilingual natural language processing by incorporating language detection, language-specific tokenization, and language-aware models or a single multilingual model. In some embodiments, the system performs automatic language identification on incoming voice input and routes processing to a language-specific pipeline or uses a shared multilingual model that accepts language tag inputs.

The system includes one or more data stores, such as a user profile database, merchant offers database, campaign metadata repository, and historical interaction store. The merchant offers database stores offer content, eligibility rules, inventory constraints, pricing information, and attribution metadata. The user profile database stores user identifiers, opt-in/opt-out status, stored payment credentials (where permitted), and personalization vectors.

A session manager component tracks active user sessions and maintains continuity of context across devices and modalities. The session manager is configured to bind identifiers across devices (for example, by authenticated user account linkage or temporary session tokens) so that an in-progress offer session on a first device can be continued on a second device.

The system exposes application programming interfaces (APIs) and developer integration points to enable third-party integration with commerce platforms, ad networks, payment providers, and large language model (LLM) services. APIs include endpoints for offer retrieval, offer acceptance, offer metrics ingestion, and event logging.

Offer generation follows an ordered process in some embodiments: (a) receive voice input and perform ASR; (b) perform language detection and NLU to extract intent, entities, and slot values; (c) retrieve relevant contextual and profile data; (d) execute a hierarchical search and matching process against merchant offers; (e) invoke the generative AI engine to synthesize candidate offer(s) or to tailor candidate offers; (f) score and rank candidate offers using an offer ranking module; (g) format offers for the target device and output channel; (h) deliver the offer; and (i) capture interaction data and update models.

The hierarchical search module may implement a two-phase search strategy: a first phase that prioritizes brand-specific and high-relevance matches when brand names or explicit product identifiers are detected, and a second phase that performs broader keyword or taxonomy-based matching when brand information is absent. The search module applies filters for inventory, geographic eligibility, merchant bid price, and campaign scheduling.

The offer ranking module evaluates candidate offers against multiple criteria including predicted relevance, historical conversion probability, merchant constraints, bid or payout parameters, and user eligibility. The ranking module outputs an ordered list of offers and may attach a confidence score to each offer. A business rules engine enforces hard constraints prior to offer delivery.

Offers may include interactive prompts that allow the user to accept, reject, request more information, defer, or perform a transaction. Responses are captured by the NLU and routed to the appropriate fulfillment modules. If the user accepts an offer that triggers a transaction, the system may facilitate checkout by invoking a payment module, which may use stored credentials, third-party payment processors, or redirect URIs to merchant checkout pages.

The adaptive learning module uses online or offline learning techniques to update model parameters based on interaction outcomes. Interaction outcomes include explicit accept/reject signals, partial engagement (e.g., listening time), eventual purchases, and post-interaction metrics. Models are retrained periodically or updated incrementally using mechanisms such as gradient updates, reinforcement learning with reward signals, or supervised learning from logged outcomes.

To prevent repetitive or irrelevant offers, the system maintains a per-user offer exposure history and applies diversity and frequency rules. The system may implement a suppression list per user to avoid re-presenting previously rejected offers or offers from the same merchant within a configurable time window.

The system supports device-specific presentation formatting. For audio-only devices, offer content is synthesized into speech using text-to-speech (TTS) engines configured for the detected language and suitable voice profile. For visual devices, offers may be rendered as card-style UI elements, modal overlays, or inline text with images. For haptic devices, the system may provide a tactile prompt sequence and a short audio notification.

The system is capable of operating in synchronous and asynchronous modes. In synchronous modes, the offer is presented during or immediately after the user's utterance. In asynchronous modes, the system schedules offer delivery for a later time (for example, after a session timeout or during an idle period) and may queue notifications for later retrieval.

In certain embodiments, the system implements integration with LLMs or conversational AI platforms by intercepting or receiving a textual prompt, performing relevance scoring against merchant triggers, and inserting or appending offer content to the LLM's response stream. Integration may be direct (via API) or indirect (via webhooks or middleware).

The system includes analytics and reporting that capture engagement metrics, conversion rates, revenue, and A/B test outcomes. These metrics are used to generate campaign performance reports and to inform merchant billing and settlement.

The architecture contemplates failover and fallback strategies. If ASR confidence is below a threshold, the system may prompt the user for clarification, fall back to a text-based interface, or route the request for manual review. If network connectivity is unavailable, the client device may present cached offers or defer offer delivery until reconnection.

The invention contemplates alternative embodiments in which some processing is performed client-side to reduce latency or to maintain privacy. For example, ASR and initial intent extraction may occur on the device with only a hashed or minimal context vector transmitted to the cloud for offer generation.

The system may include an administrative interface allowing merchants to upload offers, set targeting rules, and specify creative assets. Merchant interfaces may expose campaign dashboards and allow merchants to set bid prices, inventory constraints, and temporal targeting.

The system supports incentives and monetization models including pay-per-conversion, pay-per-impression, and incentive-based discounts where a user may receive an immediate discount in exchange for listening to a sponsored message. The discount parameters are generated and enforced by the generative AI engine and business rules engine and are recorded for reconciliation.

Security measures include encrypted communication channels, tokenization of payment data, audit logs, and role-based access controls for administrative components. In some embodiments, cryptographic integrity checks and secure attestation are used to verify client device authenticity.

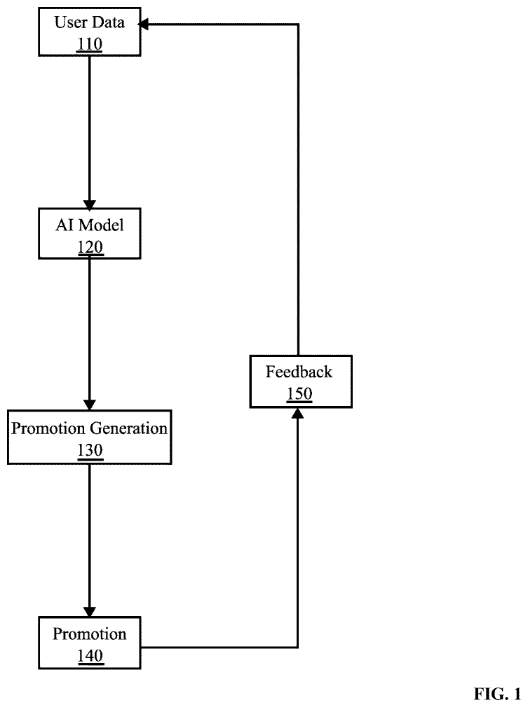

FIG. 1 is a system block diagram illustrating a representative embodiment of the generative offer system. In some embodiments, the system 100 comprises a plurality of client devices 102 (e.g., smartphones, smart speakers, wearable devices, smart televisions, XR/VR headsets). Each client device 102 includes one or more microphones 104 and one or more output interfaces 106 (audio, display, haptic). Client devices 102 are coupled via a network 108 (which may include cellular, Wi-Fi, or private networks) to a cloud coordination layer 110.

The cloud coordination layer 110 comprises an API gateway 112, a session manager 114, a multilingual ASR/NLU module 116, a language detection module 118, a contextual analysis module 120, a merchant offers database 122, a generative AI engine 124, an offer ranking module 126, an output formatting module 128, an adaptive learning module 130, a payment/fulfillment module 132, and an analytics/reporting module 134. A privacy/compliance module 136 interfaces with the data stores and determines processing permissions and anonymization flows.

In operation, audio captured at microphones 104 is encoded and transmitted to the cloud coordination layer 110. The API gateway 112 authenticates requests and forwards audio payloads to the multilingual ASR/NLU module 116. The multilingual ASR/NLU module 116 converts audio to text, detects utterance boundaries, and extracts intents and entities. Language detection module 118 confirms or refines language tags for subsequent processing.

The contextual analysis module 120 retrieves user context from a user profile store 140 and environmental context from device and network telemetry. Concurrently, the hierarchical search module (part of or cooperating with 122) queries the merchant offers database 122 for offers matching extracted entities, keywords, and taxonomies. Matching offers and dynamic candidate templates are provided to the generative AI engine 124.

The generative AI engine 124 synthesizes candidate offers using templates and dynamic generation conditioned on the user context and merchant constraints. Candidate offers are provided to the offer ranking module 126, which scores each candidate according to predicted engagement and conversion metrics and applies merchant and regulatory constraints.

The output formatting module 128 transforms the top-ranked offer into a format appropriate for the target device and output channel e.g., TTS markup for audio, JSON card payload for visual display, or haptic instructions. The formatted offer is delivered back to the client device 102 through the session manager 114 and API gateway 112.

If the user interacts with the offer (for example, accepts or requests more information), interaction events are routed to the payment/fulfillment module 132 and recorded in the analytics/reporting module 134. The adaptive learning module 130 consumes interaction events, anonymizes data via privacy/compliance module 136 as required, and updates model parameters used by the generative AI engine 124 and ranking module 126.

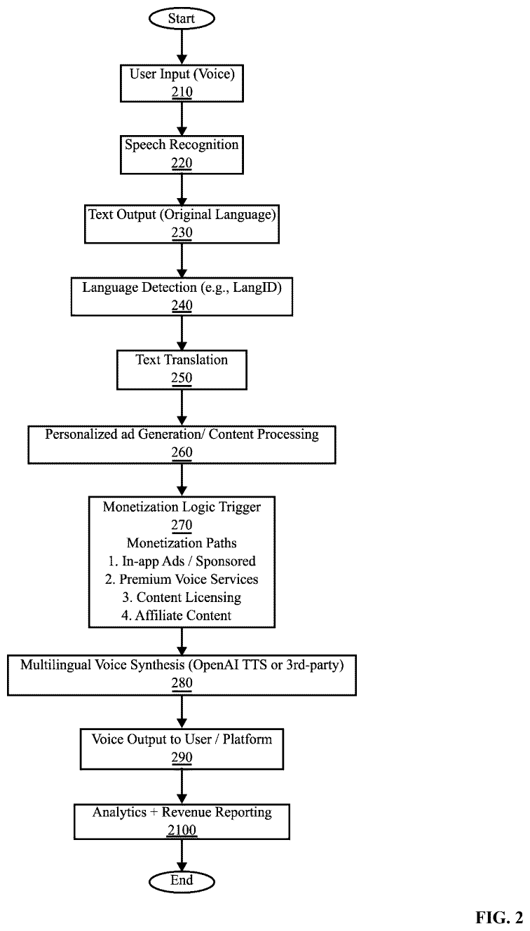

FIG. 2 illustrates integration of the generative offer system across device classes and platforms. In some embodiments, FIG. 2 depicts multiple client contexts 200a-200e representing a smartphone 202, smart speaker 204, wearable 206, smart television 208 and XR/VR device 210. Each client context includes device-specific front-end handling (for example, UI rendering engine, audio preprocessor, and local privacy controls).

For each device class, device adapters 212 implement protocol translation, local caching, and partial processing. For example, a wearable adapter may limit offer verbosity to conserve battery and screen space, while a VR adapter may supply 3D-spatialized audio and in-world visual overlays. FIG. 2 further shows integration pathways to external platforms such as LLM services 214 and third-party commerce systems 216. Integration may be implemented via secure API endpoints, message queues, or brokered middleware.

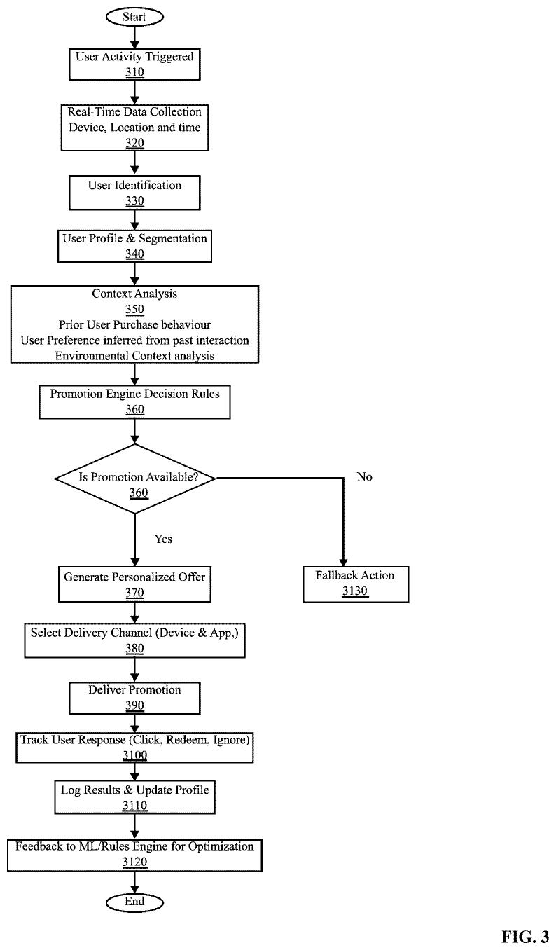

FIG. 3 is a flow diagram depicting a representative method 300 for generating and delivering a personalized promotional offer. At 302, the system receives spoken input from the user. At 304, the system performs ASR and language detection to obtain a textual representation of the utterance and an associated language tag. At 306, NLU extracts intent, entities, and slots (e.g., product category, price limit). At 308, the system retrieves user context including purchase history and session state.

At 310, the hierarchy search process queries the merchant offers database for candidate offers satisfying explicit user constraints and campaign rules. At 312, the generative AI engine composes or tailors offers; at 314 the ranking module scores candidates; at 316 the system applies business and regulatory filters to remove ineligible offers. At 318, the output formatter constructs final content for delivery. At 320 the offer is delivered to the user and at 322 the system monitors user response and logs interaction events. At 324, logged events are processed by the adaptive learning module to update models and campaign heuristics.

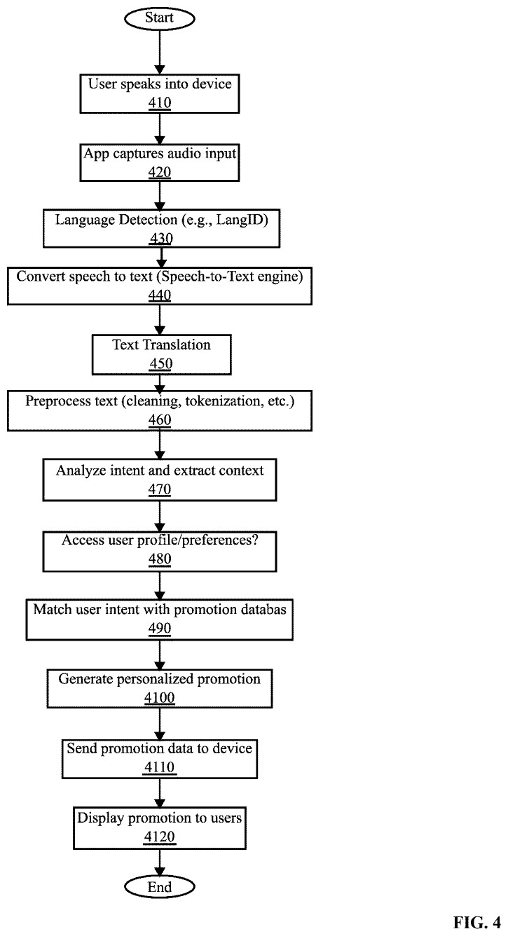

FIG. 4 is a flow diagram illustrating the adaptive learning and feedback loop. At 402, interaction events are collected (acceptances, rejections, partial listens, purchase completions, time-to-conversion). At 404, data are anonymized and aggregated to produce training datasets. At 406, the system executes periodic retraining jobs or online updates for the generative AI engine and ranking models. At 408, model validation and evaluation are performed using holdout data, A/B testing metrics, and key performance indicators. At 410, validated model updates are promoted to production and propagated to the offer generation pipeline. At 412, suppression and diversity lists are updated to enforce non-repetition rules.

The description of FIG. 1-4 above contemplates numerous variations. For example, ASR/NLU module 116 may be implemented using multiple models running in ensemble, where an initial lightweight model runs on device for responsiveness and a stronger cloud model produces final transcription and intent. In another embodiment, the generative AI engine 124 uses templated output constrained by merchant legal copy, with dynamic fields filled by the engine rather than free-form generation, thereby supporting compliance and merchant control.

In some embodiments, the system supports cross-session personalization whereby long-term user vectors are stored and periodically compressed to reduce storage and computational overhead. Long-term vectors may be updated using incremental learning techniques and may be maintained in encrypted form to preserve privacy.

The detailed operation of the adaptive learning module 130 contemplates both supervised and reinforcement learning modes. In supervised modes, training labels are derived from logged conversions and explicit user feedback. In reinforcement modes, the system defines a reward function reflecting business objectives (e.g., net revenue per interaction) and updates a policy model using collected reward signals.

The languages and dialects supported are not limited and may include, without limitation, any human language or dialect supported by available ASR/NLU models. Language support may be expanded by incorporating language pack models or leveraging third-party language services.

The system contemplates mechanisms to avoid adverse user experiences such as unsolicited intrusions. For example, a context threshold is computed combining ASR intent confidence and relevance score; only when the combined threshold is exceeded will the system present an interruptive offer. Otherwise, the system may present non-interruptive suggestions or defer offer presentation.

The disclosure also contemplates embodiments for enterprise deployment. In such embodiments, the system may run within an enterprise cloud or private data center with merchant data and user data controlled under enterprise governance. APIs for enterprise use may include extended authentication and logging for auditability.

The foregoing detailed description provides numerous specific examples of system components, data flows, and algorithmic functions to illustrate the operation of the invention and support claims directed to those features. The invention is not limited to the specific embodiments described; those skilled in the art will recognize ways to modify, substitute, or extend the described embodiments without departing from the scope of the invention as defined in the appended claims.

What is claimed is:

1. A system for generating and delivering real-time personalized promotional offers, comprising:
a. at least one voice input device configured to receive a spoken request from a user in at least one of a plurality of languages or dialects;
b. at least one multilingual natural language processing engine configured to interpret the spoken request and extract contextual data;
c. at least one contextual analysis module configured to determine user-specific context based on at least one of: prior purchase history, inferred preferences, historical interaction data, environmental parameters, or real-time behavioral signals;
d. at least one generative artificial intelligence engine or equivalent generative computational model configured to generate at least one promotional offer in real time based on the interpreted request and the user-specific context;
e. at least one adaptive learning module configured to update the generative artificial intelligence engine or equivalent computational model using data from subsequent user interactions; and
f. at least one output interface configured to deliver the promotional offer through at least one of: audio output, visual display, or haptic feedback.

2. The system of claim 1, wherein the contextual analysis module is further configured to incorporate geographic location, device type, and time of day in determining the user-specific context.

3. The system of claim 1, wherein the generative artificial intelligence engine or equivalent computational model is trained using anonymized transaction data, simulated interactions, and live feedback signals.

4. The system of claim 1, wherein the output interface is configured to present the promotional offer within a virtual reality, augmented reality, mixed reality, or extended reality environment.

5. A method for generating and delivering real-time personalized promotional offers, the method comprising:
a. receiving, via at least one voice input device, a spoken request from a user in at least one of a plurality of languages or dialects;
b. processing the spoken request with at least one multilingual natural language processing engine to interpret the request and extract contextual data;
c. determining user-specific context based on at least one of: prior purchase history, inferred preferences, historical interaction data, environmental parameters, or real-time behavioral signals;
d. generating, using at least one generative artificial intelligence engine or equivalent computational model, at least one promotional offer in real time based on the interpreted request and the user-specific context;
e. delivering the at least one promotional offer through at least one of: audio output, visual display, or haptic feedback; and
f. updating the at least one generative artificial intelligence engine or equivalent computational model with interaction data to improve future offer generation.

6. The method of claim 5, further comprising: integrating the generated promotional offer with an e-commerce platform for immediate transaction completion.

7. The method of claim 5, wherein delivering the promotional offer comprises providing an incentive in exchange for consuming a brief sponsored message.

8. The method of claim 5, wherein updating the generative artificial intelligence engine or equivalent computational model includes modifying the offer generation parameters based on acceptance rates, rejection rates, and user feedback.

9. A non-transitory computer-readable medium storing instructions which, when executed by at least one processor, cause the processor to perform operations comprising:
a. receiving a spoken request in at least one of a plurality of languages or dialects;
b. processing the spoken request using at least one multilingual natural language processing engine to interpret the request and extract contextual data;
c. determining user-specific context from historical and real-time behavioral data;
d. generating at least one personalized promotional offer using at least one generative artificial intelligence engine or equivalent computational model; and
e. delivering the personalized promotional offer through one or more output channels.

10. The non-transitory computer-readable medium of claim 9, wherein the instructions further cause the processor to adapt the promotional offers in real time in response to changes in contextual data during an active interaction session.

11. The non-transitory computer-readable medium of claim 9, wherein the instructions further cause the processor to translate promotional content into the detected user language or dialect prior to delivery.
